(19) United States
(12) Patent Application Publication
(10) Pub. No.: US 2017/0013852 A1
(43) Pub. Date: Jan. 19, 2017

(54) PROTEIN PRODUCTS AND METHODS FOR PRODUCING THEM

(71) Applicant: VALIO LTD., Helsinki (FI)

(72) Inventors: Kirsi RAJAKARI, Espoo (FI); Maria HEIKKILÄ, Espoo (FI); Päivi MYLLÄRINEN, Helsinki (FI)

(21) Appl. No.: 15/300,978

(22) PCT Filed: Mar. 31, 2015
(86) PCT No.: PCT/FI2015/050229

§ 371 Date: Sep. 30, 2016

(30) Foreign Application Priority Data
Mar. 31, 2014 (FI) 20145305

(51) Int. Cl. A23C 19/032; A23C 19/076; A23C 19/028

(52) U.S. Cl. CPC A23C 19/0328; A23C 19/0285; A23C 19/0323; A23C 19/076

(57) ABSTRACT

The present invention relates to a process for producing an acidified protein product, such as quark.

### FIELD OF THE INVENTION

The invention relates to methods for preparing acidified protein products. Further, the invention relates to acidified protein products, especially to acidified milk protein products, such as quarks.

### BACKGROUND OF THE INVENTION

Raw milk contains in addition to water (about 87%), fat (about 4.5%), lactose (about 5%) and protein (about 3.3%) also minerals, trace elements and vitamins. The proteins of milk belong to casein and whey proteins. Typically the ratio of casein protein to whey protein in cow's milk is about 80:20. Casein make up about 80% of the proteins in cow milk and are divided into alpha-, beta- and kappa-caseins. The molecular sizes of caseins are in the range of 19-23 kDa. In milk, casein exists in groups of molecules that are called micelles. These particles/micelles consist of casein, calcium, inorganic phosphate and citrate ions. In one casein particle, there are about 20 000 single casein protein molecules. Casein particle has a porous structure containing water about 3 g per 1 g of casein. The major whey proteins in milk are beta-lactoglobulin and alpha-lactalbumin having molecular sizes of 14-18 kDa.

Quark is unripened fresh cheese typically made from pasteurized skim milk by adding an acidifier and a small amount of rennet to the milk. An acid curd is formed which is separated from the whey by means of various separating techniques. Quark has a smooth texture and mild, acid flavour. Quark can be flavoured or blended with fruits, nuts, etc., and is typically used in cooking, in baking, in confectionery products or as a dessert. There is continuous need for protein-rich dairy products in the present market. In addition, there is a growing need for methods of preparing acidified protein products which are protein-rich and have increased nutritional value, in economical and environmentally friendly way.

### BRIEF DESCRIPTION OF THE INVENTION

The present invention relates to a method for producing an acidified protein product, comprising the steps of:
a) providing a casein containing concentrate starting material,
b) optionally adjusting the protein content of the casein containing concentrate material,
c) optionally supplementing the starting material with carbohydrate,
d) heat-treating the material,
e) cooling the heat-treated material to provide a cooled material,
f) subjecting the cooled material to a treatment with a crosslinking and/or a protein deamidating enzyme,
g) subjecting the cooled material to a treatment with an acidifier,
h) optionally subjecting the material to a treatment with a coagulant,
i) souring the material to provide an acidified protein product having pH-value 5.2 or less,
j) mixing the acidified protein product,
k) optionally homogenizing or treating with smoothing device the acidified milk product,
l) optionally packing the product.

Specifically, the present invention relates to a method for producing an acidified protein product, comprising the steps of:
a) providing a casein containing concentrate starting material selected from an ultrafiltration retentate of a milk raw material or a casein concentrate obtained from microfiltration of a milk raw material,
b) optionally adjusting the protein content of the casein containing concentrate material,
c) optionally supplementing the starting material with at least one carbohydrate selected from mono- and/or disaccharides,
d) heat-treating the material,
e) cooling the heat-treated material to provide a cooled material,
f) subjecting the cooled material to a treatment with a crosslinking and/or a protein deamidating enzyme,
g) subjecting the cooled material to a treatment with an acidifier,
h) optionally subjecting the material to a treatment with a coagulant,
i) souring the material to provide an acidified protein product having pH-value 5.2 or less,
j) mixing the acidified protein product,
k) optionally homogenizing or treating with smoothing device the acidified milk product,
l) optionally packing the product.

The present invention relates also to an acidified protein product, such as quark or fresh cheese, produced according to the method of the invention.

The objects of the invention are achieved by methods and products characterized by what is stated in the independent claims. The preferred embodiments of the invention are disclosed in the dependent claims.

### DETAILED DESCRIPTION OF THE INVENTION

There is currently a continuous need for acidified protein products in the market. The present invention is based on the finding that treating a casein containing concentrate material with a crosslinking and/or a protein deamidating enzyme and an acidifier, in either order, produces a product without producing whey. The traditional methods for manufacturing quark, such as the thermo quark method, produce whey, which as an acidic liquid having a high concentration of lactic acid, cannot be utilized in food industry, and is mainly exploited as an animal feed. Thus, in the method of the present invention the production of this unwanted by-product is avoided. Further, in the method of the present invention the step of separating whey from the quark mass in not needed, and accordingly also equipment for thermization (pasteurization), whey separation and whey evaporation, as well as separate tanks or silos, are unnecessary. An additional advantage of the method of the present invention is the reduced consumption of milk compared to the traditional methods. In thermo quark method the milk consumption is about 4.5 l/kg (quark) and in the method of the present invention the milk consumption is about 3.5 l/kg (quark). Further, when a crosslinking and/or a protein deamidating enzyme, such as a transglutaminase and/or a protein glutaminase, are being applied even lower milk consumption can be achieved.

Accordingly, the invention relates to a method for producing an acidified protein product, comprising the steps of:
a) providing a casein containing concentrate starting material selected from an ultrafiltration retentate of a milk raw material or a casein concentrate obtained from microfiltration of a milk raw material,
b) optionally adjusting the protein content of the casein containing concentrate material,
c) optionally supplementing the starting material with at least one carbohydrate selected from mono- and/or disaccharides,
d) heat-treating the material,
e) cooling the heat-treated material to provide a cooled material,
f) subjecting the cooled material to a treatment with a crosslinking and/or a protein deamidating enzyme,
g) subjecting the cooled material to a treatment with an acidifier,
h) optionally subjecting the material to a treatment with a coagulant,
i) souring the material to provide an acidified milk product having pH-value 5.2 or less,
j) mixing the acidified milk product,
k) optionally homogenizing or treating with smoothing device the acidified milk product,
l) optionally packing the product.

In the method of the present invention the production of the unwanted by-product, whey, is avoided and a step of separating whey from the acidified mass is unnecessary. Accordingly in one embodiment, the method of the present invention does not comprise a whey separation step.

In the present invention, the term “casein containing concentrate starting material” refers to a casein concentrate obtained from a milk raw material by a microfiltration procedure or to a casein containing concentrate obtained from a milk raw material as an ultrafiltration retentate. In one embodiment, the casein containing concentrate starting material can be obtained from casein or an ultrafiltration (UF) powder, which is recombined into water, lactose fraction, milk or rinsing milk, milk mineral solutions, reverse osmosis (RO) retentate, RO permeate, acid whey or a combination thereof.

In one embodiment, the casein containing concentrate starting material is a casein concentrate obtained from a milk raw material by a microfiltration. The microfiltration of the milk raw material provides a casein concentrate containing casein as the main protein component, lactose, and calcium- and phosphate-ions and minor amounts of whey protein. In one embodiment, the casein concentrate contains milk proteins about 9-about 50 weight-%, of which about 4 weight-% are whey proteins. In a certain embodiment, the casein containing concentrate contains about 8-about 50 weight-% caseins. In one embodiment, the casein concentrate contains milk proteins about 9-about 50 weight-5 of which about 8.5-about 50 weight-% are caseins. In one embodiment, the ratio of casein proteins to whey proteins in the casein concentrate is in the range of about 100:0 to about 92:8. In one embodiment, the casein concentrate contains about 9-about 50 weight-% milk proteins, of which 0-about 4 weight-% are whey proteins and the ratio of casein proteins to whey proteins is in the range of about 100:0 to about 92:8. In one embodiment, the casein containing concentrate comprises milk proteins about 12-about 20 weight-% of which about 11.5-about 18.5 weight-% are caseins. In one embodiment, the ratio of casein proteins to whey proteins in the casein concentrate is in the range of about 95:5 to about 92:8. In one embodiment, the casein containing concentrate comprises milk proteins about 12-about 20 weight-%, of which about 11.5-about 18.5 weight-% are caseins, and the ratio of casein proteins to whey proteins is in the range of about 95:5 to about 92:8. In a certain embodiment, the casein concentrate contains about 20 weight-% milk proteins of which about 18.8 weight-% are caseins and about 1.2 weight-% are whey proteins. In a certain embodiment, the ratio of casein proteins to whey proteins in the casein concentrate is in the range of about 94:6. In a certain embodiment, the casein concentrate contains about 20 weight-% milk proteins of which about 18.8 weight-% are caseins and about 1.2 weight-% are whey proteins. and the ratio of casein proteins to whey proteins is about 94:6.

In one embodiment, the casein concentrate additionally contains lactose 0-about 2 weight-% and calcium about 2500-about 12500 mg/kg. In another embodiment, the calcium content is in the range of about 2500-about 5000 mg/kg. The calcium content of the casein concentrate is higher than that of cow's milk. The lactose content of the casein concentrate is lower than that of cow's milk.

In one embodiment, the casein containing concentrate starting material is a casein containing concentrate obtained from a milk raw material as an ultrafiltration retentate. In one embodiment, the casein containing concentrate is an ultrafiltration (UF) retentate which contains about 12.5 weight-% milk proteins of which about 10 weight-% are caseins and about 2.5 weight-% are whey proteins. In a further embodiment, the UF-retentate contains about 20 weight-% milk proteins of which about 16 weight-% are caseins and about 4 weight-% are whey proteins. The calcium content of the casein containing concentrate starting material obtained from a milk raw material as an ultrafiltration retentate is higher than that of cow's milk. The lactose content of the the casein containing concentrate starting material obtained from a milk raw material as an ultrafiltration retentate is lower than that of cow's milk.

In one embodiment, the casein containing concentrate starting material is a casein concentrate obtained from microfiltration of a milk raw material. Accordingly, the present invention relates to a method for producing an acidified protein product, comprising the steps of:
a) providing a casein concentrate obtained from microfiltration of a milk raw material as a casein containing concentrate starting material,
b) optionally adjusting the protein content of the casein containing concentrate material,
c) optionally supplementing the starting material with at least one carbohydrate selected from mono- and/or disaccharides,
d) heat-treating the material,
e) cooling the heat-treated material to provide a cooled material,
f) subjecting the cooled material to a treatment with a crosslinking and/or a protein deamidating enzyme,
g) subjecting the cooled material to a treatment with an acidifier,
h) optionally subjecting the material to a treatment with a coagulant,
i) souring the material to provide an acidified milk product having pH-value 5.2 or less,
j) mixing the acidified milk product,
k) optionally homogenizing or treating with smoothing device the acidified milk product,
l) optionally packing the product.

In one embodiment, the present invention relates to a method for producing an acidified protein product, comprising the steps of:
a) providing a milk raw material,
b) subjecting the milk raw material to microfiltration procedure for producing a casein containing concentrate starting material,
c) optionally adjusting the protein content of the casein containing concentrate material,
d) optionally supplementing the starting material with at least one carbohydrate selected from mono- and/or disaccharides,
e) heat-treating the material,
f) cooling the heat-treated material to provide a cooled material,
g) subjecting the cooled material to a treatment with a crosslinking and/or a protein deamidating enzyme,
h) subjecting the cooled material to a treatment with an acidifier,
i) optionally subjecting the material to a treatment with a coagulant,
j) souring the material to provide an acidified milk product having pH-value 5.2 or less,
k) mixing the acidified milk product,
l) optionally homogenizing or treating with smoothing device the acidified milk product,
m) optionally packing the product.

In one embodiment, the present invention relates to a method for producing an acidified protein product, comprising the steps of:
a) providing a casein concentrate obtained from microfiltration of a milk raw material as a casein containing concentrate starting material,
b) optionally adjusting the protein content of the casein containing concentrate material,
c) supplementing the starting material with at least one carbohydrate selected from mono- and/or disaccharides,
d) heat-treating the material,
e) cooling the heat-treated material to provide a cooled material,
f) subjecting the cooled material to a treatment with a crosslinking and/or a protein deamidating enzyme,
g) subjecting the cooled material to a treatment with an acidifier,
h) optionally subjecting the material to a treatment with a coagulant,
i) souring the material to provide an acidified milk product having pH-value 5.2 or less,
j) mixing the acidified milk product,
k) optionally homogenizing or treating with smoothing device the acidified milk product,
l) optionally packing the product. p In one embodiment, the present invention relates to a method for producing an acidified protein product, comprising the steps of:
a) providing a milk raw material,
b) subjecting the milk raw material to microfiltration procedure for producing a casein containing concentrate starting material,
c) optionally adjusting the protein content of the casein containing concentrate material,
d) supplementing the starting material with at least one carbohydrate selected from mono- and/or disaccharides,
e) heat-treating the material,
f) cooling the heat-treated material to provide a cooled material,
g) subjecting the cooled material to a treatment with a crosslinking and/or a protein deamidating enzyme,
h) subjecting the cooled material to a treatment with an acidifier,
i) optionally subjecting the material to a treatment with a coagulant,
j) souring the material to provide an acidified milk product having pH-value 5.2 or less,
k) mixing the acidified milk product,
l) optionally homogenizing or treating with smoothing device the acidified milk product,
m) optionally packing the product.

In one embodiment, the casein containing concentrate starting material is an ultrafiltration retentate of a milk raw material. Accordingly, the present invention relates to a method for producing an acidified protein product, comprising the steps of:
a) providing an ultrafiltration retentate of a milk raw material as a casein containing concentrate starting material,
b) optionally adjusting the protein content of the casein containing concentrate material,
c) optionally supplementing the starting material with at least one carbohydrate selected from mono- and/or disaccharides,
d) heat-treating the material,
e) cooling the heat-treated material to provide a cooled material,
f) subjecting the cooled material to a treatment with a crosslinking and/or a protein deamidating enzyme,
g) subjecting the cooled material to a treatment with an acidifier,
h) optionally subjecting the material to a treatment with a coagulant,
i) souring the material to provide an acidified milk product having pH-value 5.2 or less,
j) mixing the acidified milk product,
k) optionally homogenizing or treating with smoothing device the acidified milk product,
l) optionally packing the product.

In one embodiment, the present invention relates to a method for producing an acidified protein product, comprising the steps of:
a) providing a milk raw material,
b) subjecting the milk raw material to ultrafiltration procedure for producing ultrafiltration retentate as a casein containing concentrate starting material,
c) optionally adjusting the protein content of the casein containing concentrate material,
d) optionally supplementing the starting material with at least one carbohydrate selected from mono- and/or disaccharides,
e) heat-treating the material,
f) cooling the heat-treated material to provide a cooled material,
g) subjecting the cooled material to a treatment with a crosslinking and/or a protein deamidating enzyme,
h) subjecting the cooled material to a treatment with an acidifier,
i) optionally subjecting the material to a treatment with a coagulant,
j) souring the material to provide an acidified milk product having pH-value 5.2 or less,
k) mixing the acidified milk product,
l) optionally homogenizing or treating with smoothing device the acidified milk product,
m) optionally packing the product.

In one embodiment, the present invention relates to a method for producing an acidified protein product, comprising the steps of:
a) providing an ultrafiltration retentate of a milk raw material as a casein containing concentrate starting material,
b) optionally adjusting the protein content of the casein containing concentrate material,
c) supplementing the starting material with at least one carbohydrate selected from mono- and/or disaccharides,
d) heat-treating the material,
e) cooling the heat-treated material to provide a cooled material,
f) subjecting the cooled material to a treatment with a crosslinking and/or a protein deamidating enzyme,
g) subjecting the cooled material to a treatment with an acidifier,
h) optionally subjecting the material to a treatment with a coagulant,
i) souring the material to provide an acidified milk product having pH-value 5.2 or less,
j) mixing the acidified milk product,
k) optionally homogenizing or treating with smoothing device the acidified milk product,
l) optionally packing the product.

In one embodiment, the present invention relates to a method for producing an acidified protein product, comprising the steps of:
a) providing a milk raw material,
b) subjecting the milk raw material to ultrafiltration procedure for producing ultrafiltration retentate as a casein containing concentrate starting material,
c) optionally adjusting the protein content of the casein containing concentrate material,
d) supplementing the starting material with at least one carbohydrate selected from mono- and/or disaccharides,
e) heat-treating the material,
f) cooling the heat-treated material to provide a cooled material,
g) subjecting the cooled material to a treatment with a crosslinking and/or a protein deamidating enzyme,
h) subjecting the cooled material to a treatment with an acidifier,
i) optionally subjecting the material to a treatment with a coagulant,
j) souring the material to provide an acidified milk product having pH-value 5.2 or less,
k) mixing the acidified milk product,
l) optionally homogenizing or treating with smoothing device the acidified milk product,
m) optionally packing the product.

In one embodiment, the present invention relates to a method for producing an acidified protein product, comprising the steps of:
a) providing an ultrafiltration retentate of a milk raw material as a casein containing concentrate starting material,
b) optionally adjusting the protein content of the casein containing concentrate material,
c) heat-treating the material,
d) cooling the heat-treated material to provide a cooled material,
e) subjecting the cooled material to a treatment with a crosslinking and/or a protein deamidating enzyme,
f) subjecting the cooled material to a treatment with an acidifier,
g) optionally subjecting the material to a treatment with a coagulant,
h) souring the material to provide an acidified milk product having pH-value 5.2 or less,
i) mixing the acidified milk product,
j) optionally homogenizing or treating with smoothing device the acidified milk product,
k) optionally packing the product.

In another embodiment, the present invention relates to a method for producing an acidified protein product, comprising the steps of:
a) providing a milk raw material,
b) subjecting the milk raw material to ultrafiltration procedure for producing ultrafiltration retentate as a casein containing concentrate starting material,
c) optionally adjusting the protein content of the casein containing concentrate material,
d) heat-treating the material,
e) cooling the heat-treated material to provide a cooled material,
f) subjecting the cooled material to a treatment with a crosslinking and/or a protein deamidating enzyme,
g) subjecting the cooled material to a treatment with an acidifier,
h) optionally subjecting the material to a treatment with a coagulant,
i) souring the material to provide an acidified milk product having pH-value 5.2 or less,
j) mixing the acidified milk product,
k) optionally homogenizing or treating with smoothing device the acidified milk product,
l) optionally packing the product.

Microfiltration of milk raw material is performed in such a manner that the milk raw material is concentrated by a factor of 1 to 4.5 times by volume, preferably 3.5 to 4.5 times by volume. The concentration factor (cf=K) refers to the ratio of the volume of the liquid fed to the filtration to the retentate, and it is defined with the following formula: K=feed (L)/retentate (L) (L=volume). The concentration factor of ultrafiltration is typically in the range of 1 to 10. In an embodiment, the concentration coefficient is 2 to 5. In one embodiment, the microfiltration is performed in a temperature below 20° C. In another embodiment the microfiltration is performed in a temperature range of 2° C. to 20° C. In a further embodiment the temperature during microfiltration is in the range of 10° C. to 14° C. The microfiltration of the milk raw material retains major portion of the casein in the retentate whereas a major portion of the whey proteins passes into the permeate. The microfiltration is preferably carried out utilizing a uniform transmembrane pressure loop recirculating the retentate through membrane and permeate through permeate site of membrane. The microfiltration may comprise a plurality of microfiltration steps. Different steps may comprise, for instance, changing of process conditions and/or filtration membranes. A variable condition may be, for instance, filtration temperature, filtration pressure, addition of diafiltration medium (diawater), and/or concentration factor of filtration. Conditions can be changed by one or more variables. In the microfiltration comprising a plurality of microfiltration steps, more than one MF permeate and retentate fractions may be formed.

In the context of the present invention, the milk raw material refers to whole milk, cream, low-fat or skim milk, low-lactose or lactose-free milk, or milk reconstituted from milk powder, organic milk or a combination of these. Preferably, the milk raw material is skim milk. The milk raw material may be supplemented by ingredients generally used in producing milk products, such as fat or sugar fractions.

In a certain embodiment, the method of the present invention comprises a step of adjusting the protein content of the casein containing concentrate material. In the step of adjusting the protein content of the casein containing concentrate material, the casein containing concentrate material is concentrated by evaporation, for example, or supplemented with protein powder. The protein content could be raised by evaporating at low pressure and a temperature of 50-60° C., for example. When the adjustment is performed by supplementing with protein powder, the powder is recombined into a cold, ambient or warm protein containing fraction. Accordingly in one embodiment of the invention, in the step of adjusting the protein content of the casein containing concentrate material, the protein content of the material is increased. In one embodiment, the ratio of casein proteins to whey proteins in the casein containing concentrate could be regulated in this step by supplementing the material with whey powder, for example.

Thus, the present invention relates to a method for producing an acidified protein product, comprising the steps of:
a) providing a casein containing concentrate starting material selected from an ultrafiltration retentate of a milk raw material or a casein concentrate obtained from microfiltration of a milk raw material,
b) optionally increasing the protein content of the casein containing concentrate material,
c) optionally supplementing the starting material with carbohydrate selected from mono- and/or disaccharides,
d) heat-treating the material,
e) cooling the heat-treated material to provide a cooled material,
f) subjecting the cooled material to a treatment with a crosslinking and/or a protein deamidating enzyme,
g) subjecting the cooled material to a treatment with an acidifier,
h) optionally subjecting the material to a treatment with a coagulant,
i) souring the material to provide an acidified milk product having pH-value 5.2 or less,
j) mixing the acidified milk product,
k) optionally homogenizing or treating with smoothing device the acidified milk product,
l) optionally packing the product.

In the heat-treatment step, the casein containing concentrate starting material is heated up to a temperature of at least 80° C. In one embodiment, the casein containing concentrate is heated up to a temperature from 80° C. to 155° C. In another embodiment, the casein containing concentrate is heated up to a temperature of about 86° C. In another embodiment the casein containing concentrate is heated up to above 80° C. for at least 1 min. Further, in one embodiment, the casein containing concentrate is kept in a temperature of at least 80° C. for 5 to 30 minutes. In a certain embodiment, the casein containing concentrate is kept in a temperature of about 86° C. for 5 to 10 minutes.

In the cooling step, the casein containing concentrate is allowed to cool or is cooled to a temperature below 45° C. In one embodiment, the casein containing concentrate is allowed to cool or is cooled to a temperature from 25° C. to 42° C. In a certain embodiment, the casein containing concentrate is allowed to cool or is cooled to a temperature of about 29° C.

In the step of treating with a crosslinking and/or protein deamidating enzyme, the casein containing concentrate is modified with a protein glutaminase and/or a transglutaminase, a laccase or a tyrosinase. In one embodiment, the crosslinking enzyme is a transglutaminase (EC 2.3.2.13). It is commonly known that transglutaminase (TG) catalyzes the generation of covalent linkages between the glutamine and lysine amino acid residues present in the protein molecules. Of milk proteins, caseins, in particular K-casein, are the best substrates for a transglutaminase. β-casein, too, is rich in glutamine and lysine that the enzyme links together. Transglutaminase can be any transglutaminase commonly used in dairy industry. It can be derived from a microbial source, fungus, mould, fish and a mammal. In an embodiment of the invention, transglutaminase is isolated from a microbial source. There are several commercially available transglutaminase enzyme preparations that are suitable for use in the process of the invention. These include Activa®YG (Ajinomoto, Japan), Activa®MP (Ajinomoto, Japan), and Yiming-TG (Yiming Fine Chemicals Co., Ltd., China). Optimum conditions depend on the enzyme used and they can be obtained from the manufacturers of the commercial enzymes. In an embodiment of the present invention, transglutaminase is used in an amount of 0.1-1.0 U enzyme/g protein.

In another embodiment, the crosslinking enzyme is a laccase. Laccases (EC 1.10.3.2) derived from fungi and bacteria, such as, fungus Trametes hirsute, catalyze the crosslinking between carbohydrates and proteins (oxidation of aromatic compounds and cysteine) with applications in food processing for reduction of allergenicity, for example.

In a further embodiment, the crosslinking enzyme is a tyrosinase. Tyrosinases (EC 1.14.18.1) are enzymes which catalyzes the oxidation of phenols such as tyrosine, with applications in food processing for reduction of allergenicity, for example. Tyrosinases can be derived from a variety of plant, animal and fungal species, i.e. filamentous fungus Trichoderma reesei.

In one embodiment, the protein deamidating enzyme is a protein glutaminase. Protein glutaminase (PG) catalyzes the deamidation of protein bound glutamine, and glutamine is converted to glutamic acid. Protein glutaminase preparations suitable for use in the process of the invention are available. Optimum conditions depend on the enzyme used and they can be obtained from the manufacturers of the enzymes. In one embodiment of the present invention, protein glutaminase is used in an amount of 0.1-3.5 U enzyme/g protein.

In one embodiment, in the step of treating with a crosslinking enzyme and/or a protein deamidating enzyme, the material is modified with a transglutaminase and a protein glutaminase. In one embodiment of the invention, transglutaminase is used in an amount of 0.1-1.0 U enzyme/g protein and protein glutaminase is used in an amount of 0.1-3.5 U enzyme/g protein. The amount of transglutaminase in relation to the amount of protein glutaminase varies from 1:0.2 to 1:20. In one embodiment, TG:PG is in the range of 1:0.2 to 1:10, preferably in the range of 1:0.2 to 1:3.

In another embodiment, in the step of treating with a crosslinking enzyme and/or a protein deamidating enzyme, the material is modified with a laccase and a protein glutaminase. In a further embodiment, the material is modified with a tyrosinase and a protein glutaminase.

The amounts of a transglutaminase, a laccase, a trosinase and a protein glutaminase used or needed in the process of the present invention depend also on the timing of the enzyme treatment in relation to the treatment with an acidifier.

In the step of treating the material with an acidifier, the cooled material is acidified by adding a biological acidifier, e.g. a bulk starter or DVS starter (direct to vat starter), a chemical acidifier or organic or inorganic acidifiers or ferment like starters, acids and acidogens, such as gluconodelta-lactone (GDL), lactic acid, citric acid, hydrochloric acid, and oxalic acid. For instance, a mesophilic starter (Lactococcus lactis ssp. cremoris, Lactococcus lactis ssp. lactis, Leuconostoc mesenteroides ssp. cremoris and Lactococcus lactis ssp. diacetylactis) is typically used in the preparation of quark. The acidification conditions, such as temperature, time and heat treatments depend on the acidifier used and are commonly known in the field. The temperature at which acidification is carried out can vary within the range of about 4° C. to about 45° C., depending on the specific acidifier (starter) and enzyme used in the method. In an embodiment, the solution is cooled to about 29° C. In one embodiment, the acidifier is gluconodelta-lactone. In another embodiment, the acidifier is a mesophilic starter.

The treatment of the casein containing concentrate starting material with a crosslinking and/or a protein deamidating enzyme and the treatment of the casein containing concentrate starting material with an acidifier can be done simultaneously or sequentially in either order. In one embodiment, crosslinking and/or a protein deamidating enzyme and acidifier treatments are done simultaneously. In another embodiment, treatment with a crosslinking and/or a protein deamidating enzyme is done first followed by the treatment with an acidifier. In a certain embodiment, the enzyme is active during the acidification. In a further embodiment, treatment with an acidifier is done first followed by a crosslinking and/or a protein deamidating enzyme treatment. In a preferred embodiment, treatments with a crosslinking and/or protein deamidating enzyme and an acidifier are done simultaneously. In another preferred embodiment, treatment with a crosslinking and/or a protein deamidating enzyme is done first followed by treatment with an acidifier.

In the step of treating with a coagulant, the casein containing concentrate is modified with rennet or chymosin. Chymosin is the active enzyme in rennet. Chymosin cleavages the peptide bond between 105 and 106, phenylalanine and methionine, in kappa-casein. Coagulant is used in a sufficient amount. The chymosin enzyme is typically used in an amount from about 0.0001% to about 0.05%, preferably about 0.002%.

In the step of souring the material, the material is allowed to sour and ripen providing an acidified milk product having pH-value 5.2 or less. The pH-range 5.2 or less is important to the texture formation of the product. Milk protein begins to precipitate/coagulate at pH 5.2 due to souring in the product, and the structure of casein micelles opens leading to the release of calcium. In one embodiment of the invention, the material is allowed to sour for providing an acidified milk product having pH-value 5.2. In another embodiment, the material is allowed to sour for providing an acidified milk product having pH-value in the range of about 4.5 to 5.0. In a further embodiment, the material is allowed to sour for providing an acidified milk product having pH-value in the range of about 4.5 to 4.6.

In one embodiment of the present invention, the casein containing concentrate starting material is supplemented or fortified with a carbohydrate or carbohydrates. In one embodiment, the casein containing concentrate starting material is supplemented or fortified with at least one carbohydrate. The carbohydrates suitable for the present invention include mono- and disaccharides. In one embodiment, the casein containing concentrate starting material is supplemented or fortified with at least one mono- and/or disaccharide. In one embodiment, the carbohydrate supplementation is performed before the heat-treatment step.

In one embodiment, the mono- and/or disaccharides suitable for the present invention include lactose, glucose, galactose, saccharose and/or fructose. In one embodiment, the at least one mono- and/or disaccharide is selected from lactose, glucose, galactose, saccharose and/or fructose In one embodiment, the carbohydrate or a mixture of carbohydrates is added to the concentrate as such. In other words, the carbohydrate or a mixture of carbohydrates is not added to the concentrate in any form of milk, or as a part of milk or of another ingredient, for example. The carbohydrate or a mixture of carbohydrates is typically added in an amount of about 2.3% to about 5%. In one embodiment, the carbohydrate is lactose. Accordingly, the present invention relates to a method for producing a casein protein product, comprising the steps of:
a) providing a casein containing concentrate starting material selected from an ultrafiltration retentate of a milk raw material or a casein concentrate obtained from microfiltration of a milk raw material,
b) optionally adjusting protein content of the casein containing concentrate material,
c) optionally supplementing the concentrate with at least one carbohydrate selected from lactose, glucose, galactose, saccharose and/or fructose,
d) heat-treating the material,
e) cooling the heat-treated material to provide a cooled material,
f) subjecting the cooled material to a treatment with a crosslinking and/or a protein deamidating enzyme,
g) subjecting the cooled material to a treatment with an acidifier,
h) optionally subjecting the material to a treatment with a coagulant,
i) souring the material to provide an acidified milk product having pH-value 5.2 or less,
j) mixing the acidified milk product,
k) optionally homogenizing or treating with smoothing device the acidified milk product,
l) optionally packing the product.

The process of the invention may further contain additional optional process steps, such as treating with lactase, homogenisation, treating with smoothing device and/or a further-processing step in which the material is treated in a manner required by the product being prepared, for instance by adding ingredients, mixing and/or recovering the product in a manner characteristic to it. These optional steps are performed in an appropriate stage of the process known by a person skilled in the art. The selection of suitable optional steps and conditions belongs to knowledge of a person skilled in the art.

In the step of homogenizing or treating with smoothing device, the acidified protein product can be treated with a rotor stator mixer, which stretches proteins. By homogenizing or treating with a rotor stator mixer, the texture of the acidified protein product, such as quark, is modified as uniform and smooth. The acidified protein product can alternatively be modified only slightly, with a screw mixer (KS Karl Schnell, Germany) or with a flex mix-mixer (SPX, Denmark), for example, to produce tvorog, which has grainy texture. Tvorog can be treated further with a homogenizer or a rotor stator mixer to produce smooth quark.

In the present invention, casein containing concentrate material can be supplemented with minerals or milk minerals. A milk mineral refers to, for example, a salt described in publication EP 1061811 B1, i.e. a milk mineral powder known as trademark Valio Milk Mineral Powder VMMP (Valio Oy). Other feasible milk-based mineral products include such trademarks as Capolac® MM-0525 BG (Arla Foods Ingredients), Vitalarmor CA (Armor Proteins) and Sodidiet 40 MI (Sodiaal Industrie).

In one embodiment, there is no need to add texturizing agents such as polysaccharides and/or fibers in the present method for producing the acidified protein product. Accordingly, the products produced by the method of the invention are free of texturizing agents.

The invention relates also to an acidified protein product produced with the method described herein. In one embodiment, the product is an acidified milk protein product. In one embodiment, the product is quark and/or granulated quark, tvorog. The quark and tvorog produced according to the present invention has typically protein content in the range of about 9 to 17%. The quark and tvorog produced according to the present invention has typically dry matter content in the range of about 14 to 24%. In another embodiment, the product is fresh cheese. The fresh cheese produced according to the present invention has typically protein content in the range of about 5 to 11%. The fresh cheese produced according to the present invention has typically dry matter content in the range of about 7 to 50%.

The product of the present invention has pH-value 5.2 or less, preferably in the range of 4.5 to 5.0. In one embodiment the product has pH-value in the range of 4.5 to 4.6.

The protein product of the present invention can be flavored and/or seasoned by adding desired flavors and/or seasonings during the manufacturing process to the product.

The following examples are presented to further illustration of the invention without limiting the invention thereto.

### EXAMPLE 1

### Reference Quark

The reference quark was prepared from skim milk using a thermoquark method. The skim milk was pasteurized at 86° C. for 7 minutes and cooled to a temperature of 29° C. The acidifier CHN11 (Lactococcus and Leuconostoc containing starter, Chr. Hansen NS, Denmark) in an amount of 0.01%, and after two hours, rennet (Maxiren 600) in an amount of 0.00035%, was added. The mixture was allowed to sour until the pH was 4.5. After this, the acidified mixture was vigorously mixed with a blender (Ystral) and then the mass was thermized at 62° C. for 5 min and cooled to 40° C. After this the whey was separated from the mass by separation, centrifugation or draining in a sack, to produce quark and whey. A desired amount of fat is then added in the form of cream, soured cream or butter. The quark thus produced was packed in desired packages, such as cups or thermo-formed packages (cups).

### EXAMPLE 2

### Preparation of Quark from Casein Concetrate with a Transglutaminase and a Protein Glutaminase

The quark was prepared from casein concentrate, which was supplemented with 5% lactose. This starting material mixture was pasteurized at 86° C. for 7 minutes and cooled to a temperature of 29° C. The acidifier CHN11 in an amount of 0.1%, a transglutaminase enzyme (0.16 U/1 g protein) and a protein glutaminase enzyme (0.24 U/g protein) were added. After about two hours, rennet (Maxiren 600) in an amount of 0.00035%, was added. The mixture was allowed to sour until the pH was in the range of 4.5 to 4.6. After this, the acidified mixture was mixed and modified with a blender (Ystral) and homogenized. The quark thus produced was packed and cooled.

The viscosity (about 10 000 mPas) and the firmness of the quark were in the same level than those of the reference quark of Example 1. The texture was smooth and even.

### EXAMPLE 3

### Preparation of Quark from Ultrafiltration Retentate with a Transglutaminase and a Protein Glutaminase

The quark was prepared from an ultrafiltration retentate, which was supplemented with 1.4% lactose. This starting material mixture was pasteurized at 86° C. for 7 minutes and cooled to a temperature of 29° C. The acidifier CHN11 in an amount of 0.1%, a transglutaminase enzyme (0.16 U/1 g protein) and a protein glutaminase (0.24 U/g protein) were added. After about two hours, rennet (Maxiren 600) in an amount of 0.00035%, was added. The mixture was allowed to sour until the pH was in the range of 4.5 to 4.6. After this, the acidified mixture was mixed and modified with a blender (Ystral) and homogenized. The quark thus produced was packed and cooled.

The viscosity (about 10 000 mPas) and the firmness of the quark were in the same level than those of the reference quark of Example 1. The texture was smooth and even.

### EXAMPLE 4

### Preparation of Quark from Casein Concentrate with a Transglutaminase Enzyme

The quark was prepared from casein concentrate, which was supplemented with 5% lactose. This starting material mixture was pasteurized at 86° C. for 7 minutes and cooled to a temperature of 29° C. The acidifier CHN11 in an amount of 0.1% and a transglutaminase enzyme (0.16 U/1 g protein) were added. After about two hours, rennet (Maxiren 600) in an amount of 0.00035%, was added. The mixture was allowed to sour until the pH was in the range of 4.5 to 4.6. After this, the acidified mixture was mixed and modified with a blender (Ystral) and homogenized. The quark thus produced was packed and cooled.

The texture of the quark was more viscous (about 12 000 mPas) and firmer than that of the reference quark of Example 1. The texture was smooth and even.

### EXAMPLE 5

### Preparation of Quark from Casein Concetrate with a Protein Glutaminase Enzyme

The quark was prepared from casein concentrate, which was supplemented with 5% lactose. This starting material mixture was pasteurized at 86° C. for 7 minutes and cooled to a temperature of 29° C. The acidifier CHN11 in an amount of 0.1% and protein glutaminase enzyme (0.26 U/1 g protein) were added and after about two hours, rennet (Maxiren 600) in an amount of 0.00035%, was added. The mixture was allowed to sour until the pH was in the range of 4.5 to 4.6. After this, the acidified mixture was mixed and modified with a blender (Ystral) and homogenized. The quark thus produced was packed and cooled.

The texture of the quark was less viscous (about 5000 mPas) than that of the reference quark of Example 1. The texture was smooth and even.

### EXAMPLE 6

### Preparation of Tvorog from Casein Concentrate with Transglutaminase Enzyme

Tvorog was prepared from casein concentrate, which was supplemented with 5% lactose. This starting material mixture was pasteurized at 86° C. for 7 minutes and cooled to a temperature of 29° C. The acidifier CHN11 in an amount of 0.1% and transglutaminase enzyme (0.16 U/1 g protein) were added and after about two hours, rennet (Maxiren 600) in an amount of 0.00035%, was added. The mixture was allowed to sour until the pH was in the range of 4.8 to 5.0. After this, the acidified mixture was mixed using a screw mixer (KS Karl Schnell). The tvorog thus produced was packed and cooled.

The tvorog was more viscous (more than about 12 000 mPas) and firmer than the products produced in Examples 2 to 5. The texture was grainy.

### EXAMPLE 7

### Preparation of Fresh Cheese from Casein Concentrate with Transglutaminase Enzyme

Fresh cheese was prepared from casein concentrate, which was supplemented with 19% cream powder having fat content of 80% and lactose content of 3.5%. The temperature was raised up to 55° C. in order to dissolve the fat. After this, the mixture was homogenized at 200/20 bar. Then the mixture was pasteurized at 86° C. for 7 minutes and cooled to a temperature of 29° C. The acidifier CHN11 in an amount of 0.1% and transglutaminase enzyme (0.16 U/1 g protein) were added and after about two hours rennet (Maxiren 600) in an amount of 0.00035% was added. The mixture was allowed to sour until the pH was in the range of 4.5 to 4.6. After this, the acidified mixture was mixed and modified with a blender (Ystral) and homogenized. The fresh cheese thus produced was packed and cooled.

The texture of the fresh cheese was smooth and it was well spreadable.

It will be obvious to a person skilled in the art that, as the technology advances, the inventive concept can be implemented in various ways. The invention and its embodiments are not limited to the examples described above but may vary within the scope of the claims.

1-22. (canceled)

23. A method for producing an acidified protein product, wherein the product is selected from quark, tvorog and fresh cheese and the method comprises the steps of:
a) providing a casein containing concentrate starting material selected from an ultrafiltration retentate of a milk raw material or a casein concentrate obtained from microfiltration of a milk raw material,
b) optionally adjusting protein content of the casein containing concentrate material,
c) supplementing the starting material with lactose, glucose, galactose, saccharose and/or fructose,
d) heat-treating the material,
e) cooling the heat-treated material to provide a cooled material,
f) subjecting the cooled material to a treatment with a crosslinking and/or a protein deamidating enzyme,
g) subjecting the cooled material to a treatment with an acidifier,
h) optionally subjecting the material to a treatment with a coagulant,
i) souring the material to provide an acidified milk product selected from quark, tvorog and fresh cheese having pH-value 5.2 or less,
j) mixing the acidified milk product,
k) optionally homogenizing or treating with smoothing device the acidified milk product,
l) optionally packing the product.

24. The method according to claim 23, wherein the process contains additional steps of
a) providing a milk raw material and
b) subjecting the milk raw material to microfiltration procedure for producing the casein containing concentrate starting material or subjecting the milk raw material to ultrafiltration procedure for producing ultrafiltration retentate as the casein containing concentrate starting material.

25. The method according to claim 23, wherein the casein containing concentrate comprises milk proteins about 9-about 50 weight-%, of which about 8.5-about 50 weight-% are caseins.

26. The method according to claim 25, wherein the casein containing concentrate comprises milk proteins about 12-about 20 weight-%, of which about 11.5-about 18.5 weight-% are caseins.

27. The method according to claim 23, wherein the material is ripened to provide an acidified milk product having pH-value in the range of 4.5 to 5.0.

28. The method according to claim 23, wherein the crosslinking enzyme is a transglutaminase.

29. The method according to claim 23, wherein the protein deamidating enzyme is a protein glutaminase.

30. The method according to claim 23, wherein the crosslinking and/or protein deamidating enzymes are a transglutaminase and a protein glutaminase.

31. The method according to claim 23, wherein in the heat treatment step (d) the material is heated up to a temperature from about 80° C. to 90° C., for about 5 minutes to about 15 minutes, specifically to about 86° C. for about 7 minutes.

32. The method according to claim 23, wherein in the cooling step (e) the material is cooled to a temperature from 4° C. to 45° C., specifically to about 29° C.

33. The method according to claim 23, wherein the acidified protein product is quark.

34. The method according to claim 23, wherein the acidified protein product is tvorog.

35. The method according to claim 23, wherein the acidified protein product is fresh cheese.

36. An acidified protein product produced according to claim 23.
